(19) United States
(12) Patent Application Publication
(10) Pub. No.: US 2009/0259692 A1
(43) Pub. Date: Oct. 15, 2009

(54) MANAGING DATABASE AGENTS

(76) Inventors: Matthew J. Bangel, Poughkeepsie, NY (US); James A. Martin, JR., Endicott, NY (US); Douglas G. Murray, Johnson City, NY (US)

Correspondence Address: HOFFMAN WARNICK LLC, 75 STATE ST, 14TH FLOOR, ALBANY, NY, 12207, US

(21) Appl. No.: 12/101,518

(22) Filed: Apr. 11, 2008

(51) Int. Cl. G06F 17/30

(52) U.S. Cl. 707/200; 707/E17.005

(57) ABSTRACT

Aspects of the present invention provide a solution for managing database agents. Specifically, an embodiment of the present invention produces a predetermined number of replica databases for running the agents. Agent scheduling documents are produced and parsed to determine on which database the agent should be run and on which database the agent should run if the first choice of databases is not functioning. The agent scheduling documents also specify whether running of a specific agent has certain prerequisites, such as a time constraint and/or whether its running is dependent upon successful completion of another agent.

### FIELD OF THE INVENTION

Aspects of the present invention generally relates to agent scheduling. Specifically, an embodiment of the present invention provides a solution for managing and/or scheduling agents interacting with one or a plurality of databases.

### BACKGROUND OF THE INVENTION

In the world of information technology it is often required that tasks be performed on a periodic basis. In a database realm, agents are often used to perform these tasks. An agent is a program snippet employing a number of functions and/or procedures that is used to perform a specific task on a database. When an agent is needed to perform a task periodically, it is often preferable that the agent be scheduled to run automatically.

### SUMMARY OF THE INVENTION

The inventors have noticed several shortcomings in the current way in which agents are normally scheduled. Currently, if a developer desires an agent to run at a particular time, the necessary parameters must be included within the code of the agent, itself. To this extent, changing scheduling of an agent requires recoding the agent. Agent schedulers for use with agents in certain database applications have a drawback of not being able to run simultaneously. Furthermore, there is no way to associate an agent with another agent such that the agent runs after the other agent has completed. Still further, if the database upon which the agent is to run is non-functioning there is no way to facilitate running of the agent and/or to notify a user that the agent has not run.

In general, aspects of the present invention provide a solution for managing database agents. Specifically, an embodiment of the present invention produces a predetermined number of replica databases for running the agents. Agent scheduling documents are produced and parsed to determine on which database the agent should be run and on which database the agent should run if the first choice of databases is not functioning. The agent scheduling documents also specify whether running of a specific agent has certain prerequisites, such as a time constraint and/or whether its running is dependent upon successful completion of another agent.

A first aspect of the present invention provides a system for managing database agents, comprising: a database replicator for producing a number of replica databases based on an original database; an agent scheduling document that includes: an identifier for an agent to be scheduled; a primary database upon which the agent is to be run, the primary database being at least one of the original database or one of the replica databases; and a prerequisite that must be satisfied before the agent is run; and a scheduling server, including a parser for parsing the agent scheduling document, the parser, for the agent scheduling document: determining, based on the prerequisite, whether the agent specified by the identifier is ready to be run, and: in case that a determination is made that the agent is ready to be run, forwarding the agent for running on the primary database.

A second aspect of the present invention provides a method for providing for management of database agents, comprising: producing a number of replica databases based on an original database; providing an agent scheduling document that includes: an identifier for an agent to be scheduled; a primary database upon which the agent is to be run, the primary database being at least one of the original database or one of the replica databases; and a prerequisite that must be satisfied before the agent is run; parsing an agent scheduling document via a scheduling server, by, for the agent scheduling document determining, based on the prerequisite, whether the agent specified by the identifier is ready to be run, and: in case that a determination is made that the agent is ready to be run, forwarding the agent for running on the primary database.

A third aspect of the present invention provides a program product stored on a computer readable for providing for maintaining database agents, comprising: program code for producing a predetermined number of replica databases based on an original database; program code for providing an agent scheduling document that includes: an identifier for an agent to be scheduled; a primary database upon which the agent is to be run, the primary database being at least one of the original database or one of the replica databases; and a prerequisite that must be satisfied before the agent is run; program code for parsing an agent scheduling documents in a scheduling server, by, for the agent scheduling document, determining, based on the prerequisite, whether the agent specified by the identifier is ready to be run, and: in case that a determination is made that the agent is ready to be run, program code for forwarding the agent for running on the primary database.

A fourth aspect of the present invention provides a method for deploying an application for managing database agents, comprising: providing a computer infrastructure being operable to: produce a predetermined number of replica databases based on an original database; provide an agent scheduling document that includes: an identifier for an agent to be scheduled; a primary database upon which the agent is to be run, the primary database being at least one of the original database or one of the replica databases; and a prerequisite that must be satisfied before the agent is run; provide a scheduling server to parse a plurality of agent scheduling documents, by, for every agent scheduling document determining, based on the prerequisite, whether the agent specified by the identifier is ready to be run, and: in case that a determination is made that the agent is ready to be run, forward the agent for running on the primary database.

A fifth aspect of the present invention provides computer software embodied in a propagated signal for scheduling of database agents, the computer software comprising instructions for causing a computer system to perform the following: produce a number of replica databases based on an original database; provide an agent scheduling document that includes: an identifier for an agent to be scheduled; a primary database upon which the agent is to be run, the primary database being at least one of the original database or one of the replica databases; and a prerequisite that must be satisfied before the agent is run; parse an agent scheduling document via a scheduling server, by, for the agent scheduling document determining, based on the prerequisite, whether the agent specified by the identifier is ready to be run, and: in case that a determination is made that the agent is ready to be run, forward the agent for running on the primary database.

A sixth aspect of the present invention provides a method for scheduling of database agents, the method comprising managing a computer infrastructure that performs the process described herein; and receiving payment based on the managing.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative computer for managing database agents according to an embodiment of the present invention.

FIG. 2 shows an example of an embodiment of the present invention having replicated databases and scheduling servers.

FIG. 3 shows a sample schedule database document according to one embodiment of an illustrative system of the present invention.

FIG. 4 shows a sample agent scheduling document according to one embodiment of an illustrative system of the present invention.

FIG. 5 shows an illustrative method flow diagram that shows the processing of schedule database documents according to one embodiment of an illustrative system of the present invention.

FIG. 6 shows an illustrative method flow diagram that shows processes for processing of each process schedule database document according to one embodiment of an illustrative system of the present invention.

FIG. 7 shows an illustrative method flow diagram for processing an individual agent schedule document according to one embodiment of an illustrative system of the present invention.

FIG. 8 shows an illustrative method flow diagram that shows processes for executing the agent according to one embodiment of an illustrative system of the present invention.

FIG. 9 shows an illustrative method flow diagram that shows processes for determining whether the agent is ready to run according to one embodiment of an illustrative system of the present invention.

FIG. 10 shows an illustrative method flow diagram that shows processing done by notification component according to one embodiment of an illustrative system of the present invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, aspects of the present invention provide a solution for managing database agents. Specifically, an embodiment of the present invention produces a predetermined number of replica databases for running the agents. Agent scheduling documents are produced and parsed to determine on which database the agent should be run and on which database the agent should run if the first choice of databases is not functioning. The agent scheduling documents also specify whether running of a specific agent has certain prerequisites, such as a time constraint and/or whether its running is dependent upon successful completion of another agent.

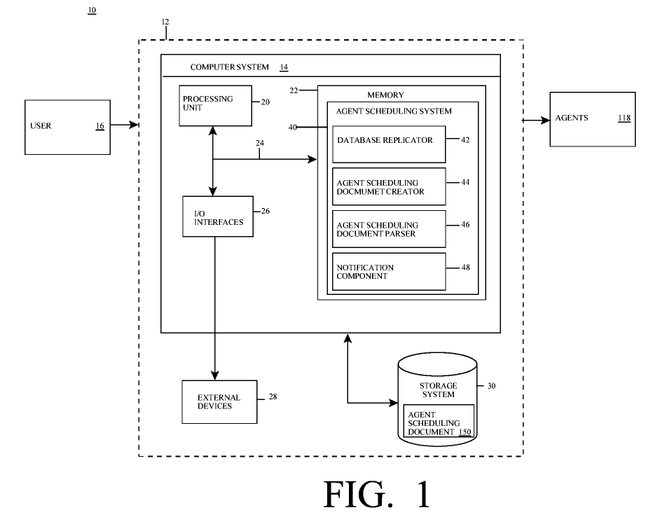

Referring now to FIG. 1, a system 10 for managing database agents 118 according to an embodiment of the present invention is shown. Specifically, FIG. 1 depicts a system 10 in which agents 118, such as in a database environment, can be scheduled by a user 16. User 16 may be the end user or, in the alternative, may be an administrator, developer, or other individual or system responsible for scheduling of database agents for the user. User 16 may use system 10 to schedule many aspects of agents 118, including, but not limited to a primary database for running an agent 118, a backup database for running an agent 118, an earliest time for running an agent 118, another agent 118 that must run to completion before the agent 118 is run, and/or the like.

As depicted, system 10 includes a computer system 14 deployed within a computer infrastructure 12. This is intended to demonstrate, among other things, that embodiments of the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by a conventional TCP/IP sockets-based protocol, and an Internet service provider could be used to establish connectivity to the Internet. Still yet, computer infrastructure 12 is intended to demonstrate that some or all of the components of system 10 could be deployed, managed, serviced, etc. by a service provider who offers to manage database agents.

As shown, computer system 14 includes a processing unit 20, a memory 22, a bus 24, and input/output (I/O) interfaces 26. Further, computer system 14 is shown in communication with external I/O devices/resources 28 and storage system 30. In general, processing unit 20 executes computer program code, such as an agent scheduling system 40, which is stored in memory 22 and/or storage system 30. While executing computer program code, processing unit 20 can read and/or write data to/from memory 22, storage system 30, and/or I/O interfaces 26. Bus 24 provides a communication link between each of the components in computer system 14. External devices 28 can comprise any devices (e.g., keyboard, pointing device, display, etc.) that enable a user to interact with computer system 14 and/or any devices (e.g., network card, modem, etc.) that enable computer system 14 to communicate with one or more other computing devices.

Computer infrastructure 12 is only illustrative of various types of computer infrastructures for implementing the invention. For example, in one embodiment, computer infrastructure 12 comprises two or more computing devices (e.g., a server cluster) that communicate over a network to perform a process described herein. Moreover, computer system 14 is only representative of various possible computer systems that can include numerous combinations of hardware and/or software. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 20 may comprise a single processing unit, or be distributed across one or more processing units in one or more locations, e.g., on a client and server. Similarly, memory 22 and/or storage system 30 can comprise any combination of various types of data storage and/or transmission media that reside at one or more physical locations. Further, I/O interfaces 26 can comprise any system for exchanging information with one or more external devices 28. Still further, it is understood that one or more additional components (e.g., system software, math co-processing unit, etc.) not shown in FIG. 1 can be included in computer system 14. However, if computer system 14 comprises a handheld device or the like, it is understood that one or more external devices 28 (e.g., a display) and/or storage system(s) 30 could be contained within computer system 14, not externally as shown.

Storage system 30 can be any type of system (e.g., a database) capable of providing storage for information under the present invention. For example, storage system 30 may be used to an original and/or replica database (not shown), agents 118, schedule database documents 130, agent scheduling documents 150, etc. To this extent, storage system 30 could include one or more storage devices, such as a magnetic disk drive or an optical disk drive. In another embodiment, storage system 30 includes data distributed across, for example, a local area network (LAN), wide area network (WAN) or a storage area network (SAN) (not shown). Although not shown, additional components, such as cache memory, communication systems, system software, etc., may be incorporated into computer system 14.

Shown in memory 22 of computer system 14 is an agent scheduling system 40, which is a software program that provides the functions of the present invention. Agent scheduling system 40 manages/schedules database agents 118. To this extent, agent scheduling system 40 includes a database replicator 42, an agent scheduling document creator 44, an agent scheduling document parser 46 and a notification component 48.

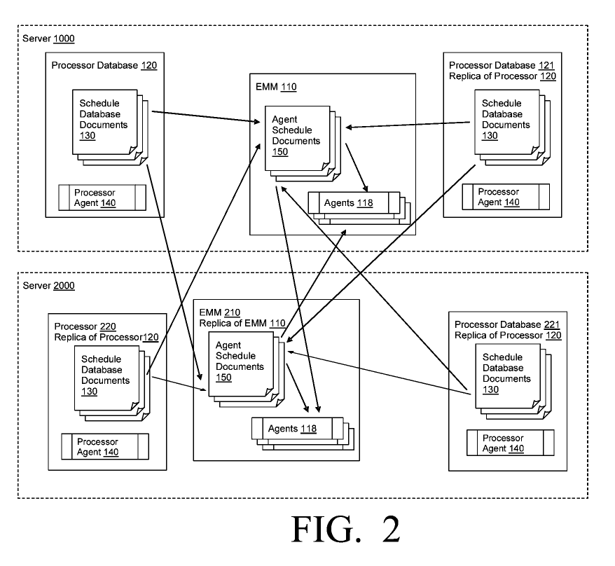

Referring now to FIGS. 1 and 2, concurrently, database replicator 42 produces a predetermined number of replica databases based on an original database. FIG. 2 shows an example in which there are two servers 1000, 2000 for running agents 118. An original database 120 has been replicated to yield a replica database 121 on server 1000 and two replica databases 220, 221 on server 2000. Each of replica databases 121, 220, 221 is an exact copy of original database 120, including identical data, schedule database documents 130, etc. Also shown in server 2000 is EMM 210, which is created as a replica of EMM 110, as will be described herein. In some current database systems, structures that run agents only allow a single agent to run on a particular database 120. Replica databases 121, 220, 221 produced by replicator 42 allow multiple agents 118 to be run on the same data simultaneously.

Agent scheduling document creator 44 allows schedule database documents 130 and agent scheduling documents 150 to be created by, for example, user 16, which control scheduling of agents 118. Schedule database documents 130 contain a set of documents that point to a list of agents that need to be run, e.g., agent scheduling documents 150. Each agent scheduling document 150 contains instructions regarding the scheduling and/or execution of a particular agent or agents 118. To this extent, agent scheduling documents 150 may be used to control every agent 118 in the system from a central location.

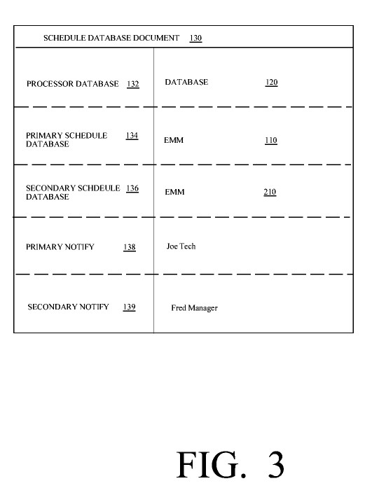

FIG. 3 shows a sample schedule database document 130, created using agent scheduling document creator 44. Schedule database document 130, in this example, has a processor database 132 that indicates which processor database 120, 121, 220, 221 is processing the schedule database document 130. In this example, processor database 132 is database 120. Schedule database document 130 also has primary schedule database 134, which points to the primary location for retrieving agent scheduling documents 150. This primary schedule database 134 can be original EMM 110 or, in the alternative, may be a replica EMM, such as EMM 210. In schedule database document 130, primary schedule database is shown as the original EMM 110.

Schedule database document 130 also contains a secondary schedule database 136, which performs the functions of primary schedule database in the case that primary schedule database 134 is not functioning properly. In schedule database document 130, secondary schedule database 136 is replica EMM 210. Schedule database document 130 may also have a primary notify 138 and secondary notify 139 for contact information for providing notification in response to certain events, for example, successful completion, unsuccessful completion, failing to run at a scheduled time, etc.

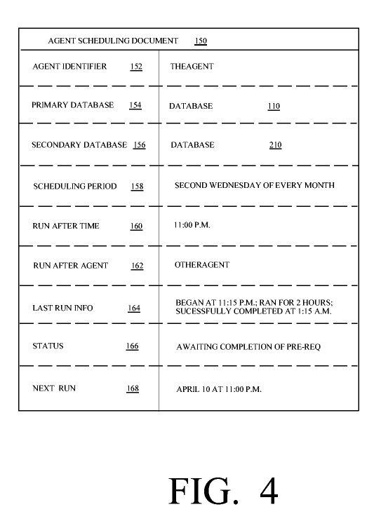

FIG. 4 shows a sample agent scheduling document 150 created by, for example, user 16, using agent scheduling document creator 44. Agent scheduling document 150, in this example, has an agent identifier 152 that indicates with which agent 118 agent scheduling document 150 is associated. Agent 118 that is associated with agent scheduling document 150 is the agent 118 that is to be scheduled using agent scheduling document 150. In this example, the agent 118 to be run is named THEAGENT. In addition, agent scheduling document 150 may also include other characteristics that are associated with scheduling of agent 118. For example, agent 118 in FIG. 4 is shown as having a primary database 154, upon which agent 118 is to be run. This primary database 154 can be original database 110 or, in the alternative, may be one of replica databases 210. In agent scheduling document 150, primary database 154 is shown as being the original database EMM 110.

Agent 118 is also shown as having a secondary database 156 upon which the agent is to be run in the case that the primary database 154 is non-operational. Agent scheduling document 150 may have a single secondary database 156, as shown herein, or, in the alternative, may have a plurality of secondary databases 156 that are tested in sequence for operability. In any case, every one of the at least one secondary database 156 is different from both primary database 154 and every other secondary database 156. As with primary database 154, each secondary database 156 may be a different one the original database 110 or one of the replica databases 210, so long as it is different from the primary database 154 and every other secondary database 156. In this example, secondary database 156 for agent 118 is shown as being replica database 210.

In addition, agent scheduling document 150 may also contain a scheduling period 158. Scheduling period 158 may occupy a single field in agent scheduling document 150 or, in the alternative, may comprise multiple fields. Scheduling period 158 may indicate a particular date, day of the week, month of the year, multiple of the foregoing, time period, etc. In the example of FIG. 4, scheduling period 158 is indicated as being the second Wednesday of every month. In the same vein, agent scheduling document 150 may also include a run after time 160. Run after time 160 is a clock time after which the agent is to run. For example, if, as in agent scheduling document 150, run after time is set to 11:00 p.m., agent 118 will not run until after 11:00 p.m. has past. Likewise, agent scheduling document 150 may also include a run after agent 162, which is a prerequisite agent 118 that must be run prior to running agent 118. In the example of FIG. 4, the agent 118 OTHERAGENT must complete prior to THEAGENT being run.

Further, agent scheduling document 150 may include information that indicate its past, current and future run status. Last run info 164 can indicate the beginning time, completion time, run time, status, etc. of the last run. This information may be used in conjunction with, e.g., scheduling period 158 and run after time 160 to calculate next run 168, which may be used by a processor database 120, 121, 220, 221 to determine whether the agent 118 specified by agent identifier 152 should be run. In addition, a status 166 could be included in agent schedule document 150, which indicates the current status of the agent 118.

Returning now to FIGS. 1 and 2, agent scheduling document parser 46 of agent scheduling system 40 uses processor agent 140 to process schedule database documents 130 to retrieve a pointer to an EMM 110, 210 for locating agent schedule documents 150 and then parses the plurality of agent schedule documents 150 in sequence to control scheduling of the agents 118.

To this extent, each of processor databases 120, 121, 220, 221, uses its processor agent 140 to parse its copy of schedule database documents 130. Upon encountering a schedule database document 130 that points to a particular primary schedule database 134 (FIG. 3), processor database 120, 121, 220, 221 retrieves agent schedule documents 150 from whichever EMM 110, 210 is designated in schedule database document 130. If primary schedule database 134 (FIG. 3) is not available, processor database 120, 121, 220, 221 retrieves agent schedule documents 150 from whichever EMM 110, 210 is designated as secondary schedule database 136 in schedule database document 150.

Upon retrieval of agent schedule documents 150, agent scheduling document parser 46 of agent scheduling system 40 has processor database 120, 121, 220, 221 parse each agent schedule document 150 in turn until there are no agent schedule documents 150 to be parsed. Upon finding an agent schedule document 150 having an indication that the particular processor database 120, 121, 220, 221 doing the processing is designated to process the particular agent schedule document 150, processor database makes a determination whether the prerequisite conditions contained in agent schedule document 150 (e.g., time 160, pre-requisite agent 162, etc.) have been satisfied. If the prerequisite conditions have been satisfied, the processor database 120, 121, 220, 221 instructs whichever EMM 110, 120 is the primary database 154 (FIG. 4) to run agent 118 specified by agent identifier 152 (FIG. 4). If the EMM 110, 120 designated as primary database 154 (FIG. 4) is not available, the processor database 120, 121, 220, 221 instructs whichever EMM 110, 120 is the secondary database 156 (FIG. 4) to run agent 118 specified by agent identifier 152 (FIG. 4). To this extent, scheduling document parser 46 allows for scheduling of all agents 118 in a system by parsing agent scheduling documents 150 in order and running agents 118 specified therein in order and on the appropriate system based on the parameters in the agent scheduling documents 118.

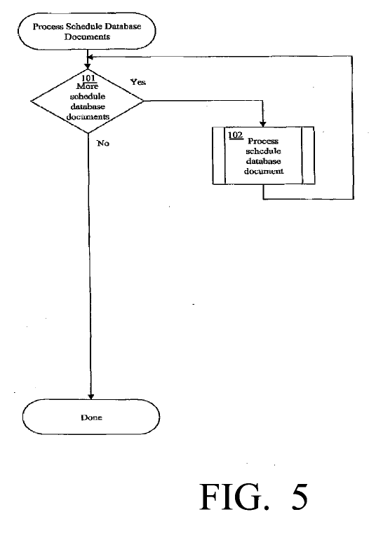

FIGS. 5-9 are flow diagrams that illustrate possible processes carried out by scheduling document parser 46. FIG. 5 shows the processing of schedule database documents 130. In process 101, a determination is made whether any more schedule database documents 130 remain to be processed. If not, processing terminates. If so, in process 102, processor database 120, 121, 220, 221 processes the next process schedule document 130 in sequence.

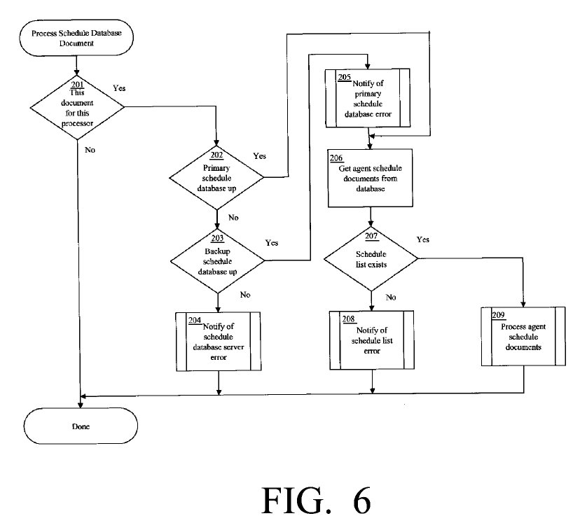

FIG. 6 shows processes for processing of each process schedule database document 130. In process 201, a determination is made as to whether the document is for the processor on which the processing is being done. If not, processing is completed. If so, process 202 gets the list of agent schedule documents 150 and processes each one that has been set up to be run by the same processor database 120, 121, 220 or 221 as process 202 is currently running on. The agent is actually run on EMM 110 or EMM 210 but is initiated from the processor database 120, 121, 220 or 221 thus allowing multiple agents running on a single database, EMM 110 or EMM 210, to be run on different server agent executors. Then a determination is made whether primary database 74 is functioning. If so, in process 206, agent schedule documents 150 are retrieved from the database and a determination is made in process 207 whether a schedule list exists. If so, the agent schedule documents are processed in process 209. If not, notification component 48 sends a notification of a schedule list error in process 208.

If, in process 202, the determination is made that primary database 74 is not functioning, in process 203, a determination is made whether secondary database 76 is functioning. If not, notification component 48 sends a notification of a schedule database server error for secondary database 76 in process 204 and processing ends. If secondary database 76 is functioning, notification component 48 sends a notification of a schedule database server error for primary database 74 in process 205. Then process flows to process 206 as before.

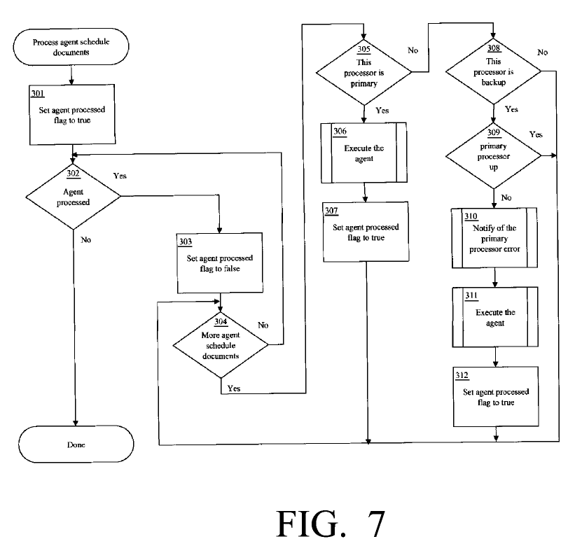

FIG. 7 shows a process for processing an individual agent scheduling document 150. In process 301 a flag indicating that agent 118 has been processed is set to true. A determination is made in process 302 as to whether agent 118 is to be processed. If not, processing terminates. If yes, in process 303, the agent processed flag is set to false, and a determination is made in process 304 whether there are more agent scheduling documents 150 to be processed. If not, processing returns to process 302. If yes, in process 305, a determination is made whether the processor that is currently processing agent scheduling document 150 is the primary processor indicated in the agent scheduling document 150. If so, in process 306, the agent is processed and in process 307, the agent processed flag is set to true. If not, a determination is made in process 308 whether the processor that is currently processing agent scheduling document 150 is a backup processor indicated in the agent scheduling document 150. If the processor is not a backup, process flows back to process 304. If the processor is a backup, a determination is made whether the primary processor is functioning in 309. If it is, process flows back to process 304. If not, notification component 48 sends a notification of a primary processor error in process 310, in process 311, the agent is processed, the agent processed flag is set to true in process 312, and process flows back to process 304.

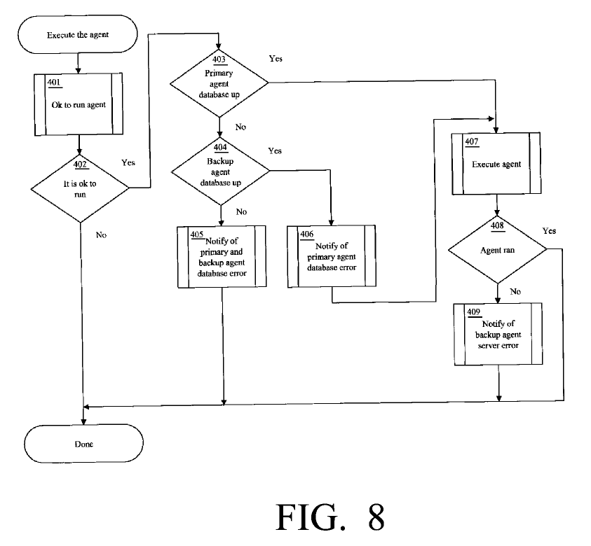

FIG. 8 shows a process flow for executing the agent 118. In process 401 and process 402 a determination is made whether it is ok to run agent 118. If not then processing terminates. If so, a determination is made in process 403 whether the primary database is functioning. If it is, agent 118 is executed in process 407 and then a determination is made in process 408 whether the agent 118 has successfully run. If so processing terminates. If not, notification component 48 sends a notification of a backup agent server error in process 409 and processing terminates.

In the case that the primary database is not functioning, a determination is made in process 404 whether the backup database is functioning. If not, notification component 48 sends a notification of primary and backup agent database error in process 405. If the backup agent database is functioning, notification component 48 sends a notification of a primary agent database error in process 406 and process goes to process 407.

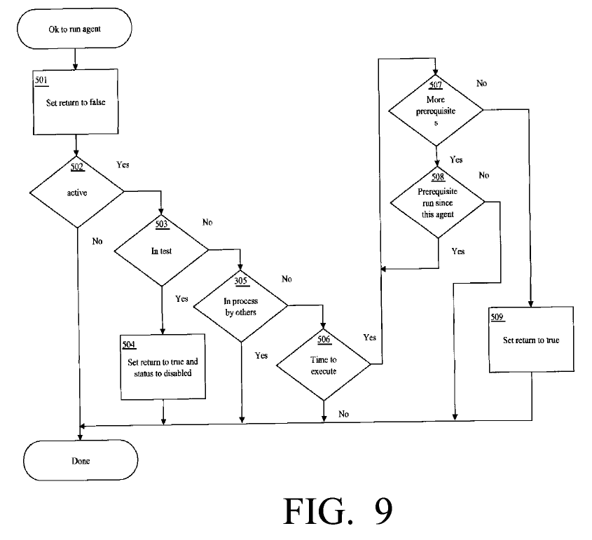

FIG. 9 shows a process flow for determining whether the agent is ready to run. In process 501, return is set to false and a determination is made in process 502 whether agent 118 is active. If not, the process terminates. If so, a determination is made in process 503 whether agent 118 is in a test mode. If so, return is set to true in process 504 and processing terminates. If not, a determination is made whether agent 118 is in process by others. If so, processing terminates. If not, a determination is made in process 506 whether it is time for agent 118 to execute, e.g., whether run after time 78 has past. If not, processing terminates. If so, a determination is made in process 507 whether there are any prerequisite agents 118, e.g., run after agent 80, which must be run prior to running of the agent. If not, then return is set to true in process 509 and process terminates. If so, a determination is made in process 508 whether the prerequisite has run in process 508. If not, process terminates. If so, processing loops to process 507.

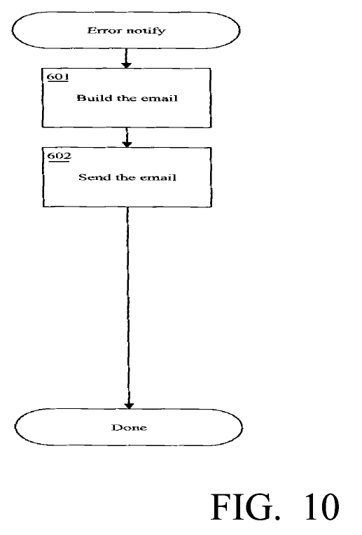

FIG. 10 shows an illustrative flow diagram of processing done by notification component 48. In process 601, an email or other notification is built with the requisite notification. In process 602, the email or other notification is sent to the appropriate party.

While shown and described herein as a method and system for scheduling database agents, it is understood that the invention further provides various alternative embodiments. For example, in one embodiment, the invention provides a computer-readable/useable medium that includes computer program code to enable a computer infrastructure to manage database agents. To this extent, the computer-readable/useable medium includes program code that implements an embodiment of the process described herein. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 22 (FIG. 1) and/or storage system 30 (FIG. 1) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a method that performs the process described herein on a subscription, advertising, and/or fee basis. That is, a service provider, such as a Solution Integrator, could offer a service that manages database agents. In this case, the service provider can create, maintain, support, etc., a computer infrastructure, such as computer infrastructure 12 (FIG. 1) that performs the process described herein for one or more entities. In return, the service provider can receive payment from the entity(s) under a subscription and/or fee agreement and/or the service provider can receive payment from the sale of advertising content to one or more third parties.

In still another embodiment, the invention provides a computer-implemented method for managing database agents. In this case, a computer infrastructure, such as computer infrastructure 12 (FIG. 1), can be provided and one or more systems for performing the process described herein can be obtained (e.g., created, purchased, used, modified, etc.) and deployed to the computer infrastructure. To this extent, the deployment of a system can comprise one or more of (1) installing program code on a computing device, such as computer system 14 (FIG. 1), from a computer-readable medium; (2) adding one or more computing devices to the computer infrastructure; and (3) incorporating and/or modifying one or more existing systems of the computer infrastructure to enable the computer infrastructure to perform the process.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A system for managing database agents, comprising:
a database replicator for producing a number of replica databases based on an original database;
an agent scheduling document that includes:
an identifier for an agent to be scheduled;
a primary database upon which the agent is to be run, the primary database being at least one of the original database or one of the replica databases; and
a prerequisite that must be satisfied before the agent is run; and
a scheduling server, including a parser for parsing the agent scheduling document, the parser, for the agent scheduling document:
determining, based on the prerequisite, whether the agent specified by the identifier is ready to be run, and:
in case that a determination is made that the agent is ready to be run, forwarding the agent for running on the primary database.

2. The system of claim 1, the agent scheduling document further including:
a secondary database upon which the agent is to be run that is different from the primary database,
wherein the parser, for the scheduling document:
determines whether the primary database of the agent scheduling document is operational, and:
in case that a determination is made that the primary database is non-operational, forwarding the agent for running on one of the secondary database.

3. The system of claim 1, wherein the scheduling document further includes a time after which the agent is to run and wherein the parser further makes a determination whether the time has past and runs the agent based on a positive determination.

4. The system of claim 1, wherein the scheduling document further includes a prerequisite agent that must be run prior to running of the agent and wherein the parser further makes a determination whether the prerequisite agent has run and runs the agent based on a positive determination.

5. The system of claim 1, further comprising a notification component for notifying an appropriate party in case that a determination is made that the primary database is non-operational.

6. The system of claim 1, further comprising a backup scheduling server being an identical replica of the scheduling server.

7. The system of claim 1, wherein the scheduling server controls execution of all agents on the system.

8. A method for providing for management of database agents, comprising:
producing a number of replica databases based on an original database;
providing an agent scheduling document that includes:
an identifier for an agent to be scheduled;
a primary database upon which the agent is to be run, the primary database being at least one of the original database or one of the replica databases; and
a prerequisite that must be satisfied before the agent is run;
parsing an agent scheduling document via a scheduling server, by, for the agent scheduling document determining, based on the prerequisite, whether the agent specified by the identifier is ready to be run, and:
in case that a determination is made that the agent is ready to be run, forwarding the agent for running on the primary database.

9. The method of claim 8, the agent scheduling document further including:
a secondary database upon which the agent is to be run that is different from the primary database,
wherein the parsing, for the agent scheduling document, further includes:
determining whether the primary database of the agent scheduling document is operational, and:
in case that a determination is made that the primary database is non-operational, forwarding the agent for running on one of the secondary database.

10. The method of claim 8, wherein the prerequisite includes a time after which the agent is to run and wherein the parsing further determines whether the time has past and runs the agent based on a positive determination.

11. The method of claim 8, wherein prerequisite includes a prerequisite agent that must be run prior to running of the agent and wherein the parsing further includes making a determination whether the prerequisite agent has run and running the agent based on a positive determination.

12. The method of claim 8, further comprising notifying an appropriate party in case that a determination is made that the primary database is non-operational.

13. The method of claim 8, further comprising providing a backup scheduling server being an identical replica of the scheduling server, wherein the scheduling server and backup scheduling server control execution of all agents on the system.

14. A program product stored on a computer readable for providing for maintaining database agents, comprising:
program code for producing a predetermined number of replica databases based on an original database;
program code for providing an agent scheduling document that includes:
an identifier for an agent to be scheduled;
a primary database upon which the agent is to be run, the primary database being at least one of the original database or one of the replica databases; and
a prerequisite that must be satisfied before the agent is run;
program code for parsing an agent scheduling documents in a scheduling server, by, for the agent scheduling document, determining, based on the prerequisite, whether the agent specified by the identifier is ready to be run, and:
in case that a determination is made that the agent is ready to be run, program code for forwarding the agent for running on the primary database.

15. The program product of claim 14, the agent scheduling document further including:
a secondary database upon which the agent is to be run that is different from the primary database,
wherein the program code for parsing, for the agent scheduling document, further includes:
program code for determining whether the primary database of the agent scheduling document is operational, and:
in case that a determination is made that the primary database is non-operational, program code for forwarding the agent for running on one of the secondary database.

16. The program product of claim 14, wherein the prerequisite includes a time after which the agent is to run and wherein the program code for parsing further makes a determination whether the time has past and runs the agent based on a positive determination.

17. The program product of claim 14, wherein the prerequisite includes a prerequisite agent that must be run prior to running of the agent and wherein the program code for parsing further makes a determination whether the prerequisite agent has run and runs the agent based on a positive determination.

18. The program product of claim 14, further comprising program code for notifying an appropriate party in case that a determination is made that the primary database is non-operational.

19. The program product of claim 14, wherein the scheduling server comprises a plurality of duplicate the scheduling servers, and wherein the scheduling server controls execution of all agents on the system.

20. A method for deploying an application for managing database agents, comprising:
providing a computer infrastructure being operable to:
produce a predetermined number of replica databases based on an original database;
provide an agent scheduling document that includes:
an identifier for an agent to be scheduled;
a primary database upon which the agent is to be run, the primary database being at least one of the original database or one of the replica databases; and
a prerequisite that must be satisfied before the agent is run;
provide a scheduling server to parse a plurality of agent scheduling documents, by, for every agent scheduling document determining, based on the prerequisite, whether the agent specified by the identifier is ready to be run, and:
in case that a determination is made that the agent is ready to be run, forward the agent for running on the primary database.

21. The method of claim 20, the agent scheduling document further including:
a secondary database upon which the agent is to be run that is different from the primary database,
wherein the parsing, for the agent scheduling document, further includes:
determining whether the primary database of the agent scheduling document is operational, and:
in case that a determination is made that the primary database is non-operational, forwarding the agent for running on one of the secondary database.

22. The method of claim 20, wherein the prerequisite includes a time after which the agent is to run and wherein the parser further makes a determination whether the time has past and runs the agent based on a positive determination, and wherein the prerequisite further includes a prerequisite agent that must be run prior to running of the agent and wherein the parser further makes a determination whether the prerequisite agent has run and runs the agent based on a positive determination.
